(19) United States
(12) Patent Application Publication
(10) Pub. No.: US 2025/0210719 A1
(43) Pub. Date: Jun. 26, 2025

(54) METAL BATTERY

(71) Applicant: Sumitomo Chemical Co., Ltd, Tokyo (JP)

(72) Inventor: Antonio ATTANZIO, Godmanchester (GB)

(73) Assignee: Sumitomo Chemical Co., Ltd, Tokyo (JP)

(21) Appl. No.: 18/852,968

(22) PCT Filed: Mar. 30, 2023
(86) PCT No.: PCT/EP2023/058424

§ 371 Date: Sep. 30, 2024

(30) Foreign Application Priority Data
Mar. 31, 2022 (GB) 2204645.2

(51) Int. Cl. H01M 10/0568; H01M 4/02; H01M 4/04; H01M 4/66; H01M 10/0525; H01M 10/0569

(52) U.S. Cl. CPC H01M 10/0568; H01M 4/0407; H01M 4/661; H01M 10/0525; H01M 10/0569; H01M 2004/028

(57) ABSTRACT

A metal battery comprising an anode, an anode current collector, a cathode, a cathode current collector and a compound of formula (I) disposed between the anode and cathode wherein X is Al or B; R¹ in each occurrence is independently a substituent; and two R¹ groups may be linked to form a ring; and M⁺ is a metal cation, and wherein the anode current collector comprises zinc.

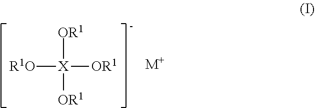

### BACKGROUND

Metal batteries are known.

Zhang et al, “Homogenous lithium plating/stripping regulation by a mass-producible Zn particles modified Li-metal composite anode” Nano Research volume 14, pages 3999-4005 (2021) discloses a LiZn/Li composite anode for a metal battery.

Zhang et al, “Regulating lithium nucleation and growth by zinc modified current collectors”, NanoResearch, 2019, 13, 45-51 discloses a copper foil anode current collector, Cu foil modified with a thin layer of zinc by an electroplating method, in order to regulate Li nucleation and the following growth processes.

Wang et al, “Lithiated zinc oxide nanorod arrays on copper current collectors for robust Li metal anodes”, 2019, 378, 122243.

Jiang et al, “Atomic layer deposition for improved lithiophilicity and solid electrolyte interface stability during lithium plating” Energy Storage Materials Volume 28, June 2020, Pages 17-26 discloses a ZnO-modified carbon fibre/Li composite anode.

CN101771166 discloses an ionic liquid electrolyte composed of certain organic lithium borate or lithium aluminate compounds and certain organic compound containing an amido functional group.

JP2004265785 discloses an ionic electrolyte material of formula (I):

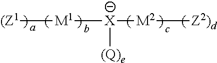

JP 2006/107793 discloses an ion having a fluorinated alkoxy group coordinated to a metallic element.

JP03409852 discloses compounds of formula:

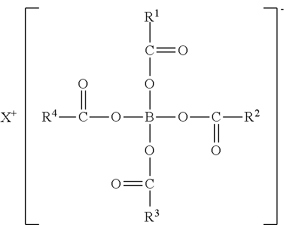

U.S. Pat. No. 8,394,539 discloses lithium salts with fluorinated chelated orthoborate anions used as electrolytes or electrolyte additives in lithium-ion batteries. The lithium salts have two chelate rings formed by the coordination of two bidentate ligands to a single boron atom.

E. Zygadlo-Monikowska et al, “Lithium conducting ionic liquids based on lithium borate salts”, Journal of Power Sources 195 (2010) 6055-6061, discloses reaction of trialkoxyborates with butyllithium to form Li{[CH₃(OCH₂CH₂)nO]₃BC₄H₉}.

Michael Rohde et al, “Li[B(OCH₂CF₃)₄]: Synthesis, Characterization and Electrochemical Application as a Conducting Salt for LiSB Batteries”, ChemPhysChem 2015, 16, 666-675 discloses formation of Li[B(OCH₂CF₃)₄] by reaction of lithium borohydride with excess 2,2,2-trifluorethanol.

R Tao et al, “Enhancement of ionic conductivity by mixing lithium borate with lithium aluminate”, discloses compounds of formula:

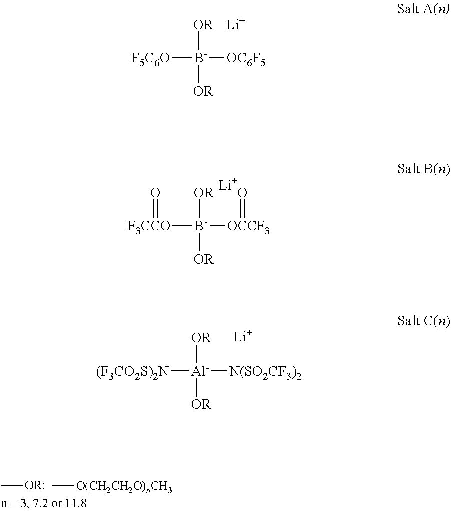

### SUMMARY

In some embodiments, the present disclosure provides a metal battery comprising an anode, a cathode, an anode current collector, a cathode current collector and a compound of formula (I) disposed between the anode and cathode:

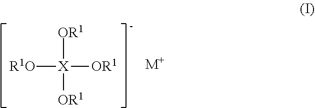

wherein X is Al or B; R¹ in each occurrence is independently a substituent; and two R¹ groups may be linked to form a ring; and M⁺ is a metal cation, and wherein the anode comprises a layer comprising zinc in contact with the anode.

Optionally, none of the R¹ groups are linked. In these embodiments, optionally each R¹ is independently a C₁₋₂₀ alkyl group wherein one or more non-adjacent C atoms of the alkyl group may be replaced with O, S, CO or COO and one or more H atoms of the alkyl group may be replaced with F. Optionally, each R¹ is independently selected from alkyl and alkyl ether groups wherein one or more H atoms may be replaced with F.

Optionally, each R¹ is the same.

Optionally, the compound contains at least 2 different R¹ groups.

In some embodiments, R¹ groups of formula (I) are linked and the compound of formula (I) has formula (Ia):

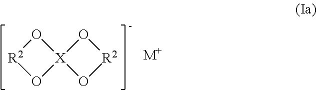

wherein R² in each occurrence is independently a divalent organic group.

Optionally, M⁺ is an alkali metal ion.

Optionally, M⁺ is a lithium ion.

Optionally, M⁺ is a solvated cation.

Optionally, a solvent:M⁺ molar ratio of the battery is no more than 10:1.

Optionally, the metal battery comprises an anode protection layer comprising the compound of formula (I) disposed between the anode and cathode.

In some embodiments, the present disclosure provides a formulation comprising or consisting of a solvent and a compound of formula (I):

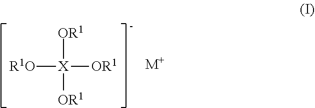

wherein X is Al or B; R¹ in each occurrence is independently a substituent and two R¹ groups may be linked to form a ring; and M⁺ is a cation, and wherein the solvent comprises a carbonate group.

Optionally, the solvent comprising a carbonate group is selected from C₂₋₁₀ alkylene carbonates and di(C₁₋₁₀ alkyl) carbonates.

Optionally, the ratio of moles of solvent:moles of M⁺ in the formulation is no more than 20:1, optionally no more than 10:1 and is optionally at least 0.5:1 or 1:1.

The formulation may comprise only one solvent comprising a carbonate group. The formulation may comprise two or more different solvents comprising a carbonate group. The formulation may comprise one or more further components, for example one or more further solvents which do not comprise a carbonate group and/or one or more polymers dissolved in the formulation. Where the formulation comprises two or more solvents the solvents are suitably miscible.

### DESCRIPTION OF DRAWINGS

FIG. 1 is a schematic illustration of a battery according to some embodiments of the present disclosure having a separator comprising a compound as described herein;

FIG. 2 is a schematic illustration of a battery according to some embodiments of the present disclosure having an anode protection layer comprising a compound as described herein;

FIG. 3 is a plot comparing Coulombic efficiencies for a device having a copper current collector and a device having a zinc current collector at a current density of 0.2 mA/cm²;

FIG. 4 is a plot comparing Coulombic efficiencies for a device having a copper current collector and a device having a zinc current collector at a current density of 0.5 mA/cm²;

FIG. 5 shows a voltage profile for a device having a copper current collector at 0.2 mA/cm2 current density;

FIG. 6 shows a voltage profile for a device having a zinc current collector at 0.2 mA/cm2 current density;

FIG. 7 shows a voltage profile for a device having a copper current collector at 0.5 mA/cm2 current density; and

FIG. 8 shows a voltage profile for a device having a copper current collector at 0.5 mA/cm2 current density.

The drawings are not drawn to scale and have various viewpoints and perspectives. The drawings are some implementations and examples. While the technology is amenable to various modifications and alternative forms, specific embodiments have been shown by way of example in the drawings and are described in detail below. The intention, however, is not to limit the technology to the particular implementations described. On the contrary, the technology is intended to cover all modifications, equivalents, and alternatives falling within the scope of the technology as defined by the appended claims.

### DETAILED DESCRIPTION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” Additionally, the words “herein,” “above,” “below,” and words of similar import, when used in this application, refer to this application as a whole and not to any particular portions of this application. Where the context permits, words in the Detailed Description using the singular or plural number may also include the plural or singular number respectively. The word “or,” in reference to a list of two or more items, covers all of the following interpretations of the word: any of the items in the list, all of the items in the list, and any combination of the items in the list. References to a layer “over” another layer when used in this application means that the layers may be in direct contact or one or more intervening layers may be present. References to a layer “on” another layer when used in this application means that the layers are in direct contact. References to an element of the Periodic Table include any isotopes of that element.

The teachings of the technology provided herein can be applied to other systems, not necessarily the system described below. The elements and acts of the various examples described below can be combined to provide further implementations of the technology. Some alternative implementations of the technology may include not only additional elements to those implementations noted below, but also may include fewer elements.

These and other changes can be made to the technology in light of the following detailed description. While the description describes certain examples of the technology, and describes the best mode contemplated, no matter how detailed the description appears, the technology can be practiced in many ways. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms.

In the following description, for the purposes of explanation, numerous specific details are set forth in order to provide a thorough understanding of implementations of the disclosed technology. It will be apparent, however, to one skilled in the art that embodiments of the disclosed technology may be practiced without some of these specific details.

A problem associated with metal batteries is dendrite formation at the metal anode of the battery. Over time, dendrite growth can result in short-circuiting of the battery with resulting in failure of the battery and a fire hazard due to flammability of battery components such as the solvent of the battery electrolyte.

The present inventors have found that dendrite formation can be suppressed by use of a current collector containing zinc and a compound of formula (I).

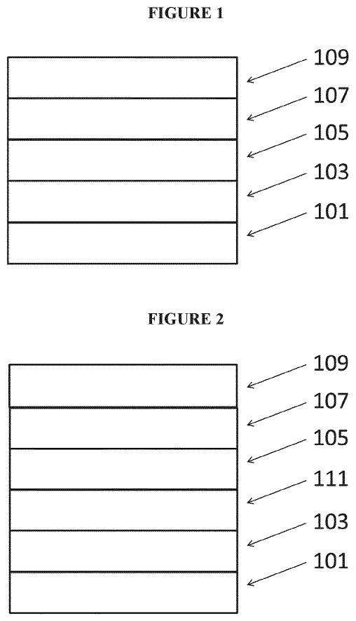

A metal battery according to some embodiments of the present disclosure is illustrated in FIG. 1. The metal battery comprises an anode current collector 101 carrying an anode 103 on a surface thereof; a cathode current collector 109 having a cathode 107 disposed on a surface thereof; and a separator 105 disposed between the anode and cathode.

The cathode may be selected from any cathode known to the skilled person, e.g. one or more layers of metal or metal alloy such as aluminium or copper.

The anode is a layer of metal, preferably lithium, which is formed over the anode current collector during charging of the battery and which is stripped during discharge of the battery.

The anode and cathode current collectors are each shown as a single layer for simplicity. The anode and cathode current collectors may each independently consist of a single layer or may have two or more layers.

The anode current collector comprises or consists of a layer comprising zinc in contact with the anode. In use, zinc and lithium at the current collector/anode interface may form a Zn—Li alloy.

The anode current collector may consist of the layer comprising or consisting of zinc. The anode current collector may comprise one or more further layers. The one or more further layers may comprise any conductive material known to the skilled person, for example aluminium or copper.

The separator comprises or consists of a compound of a compound of formula (I):

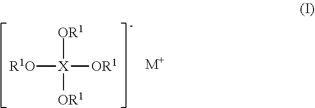

X is Al or B.

R¹ in each occurrence is independently a substituent and two R¹ groups may be linked to form a ring.

M is a cation.

FIG. 1 illustrates a battery in which the anode and cathode are separated only by a separator. In other embodiments, one or more further layers may be disposed between the anode and the separator and/or the cathode and the separator.

FIG. 2 illustrates a battery, preferably a metal battery, comprising an anode current collector 101 carrying an anode 103 on a surface thereof; a cathode current collector 109 having a cathode 107 disposed on a surface thereof; a separator 105 disposed between the anode and cathode; and an anode protection layer 111 disposed between anode and the separator. The separator may comprise or consist of a compound of formula (I) as described herein or may be any other separator known to the skilled person, for example a porous polymer having a liquid electrolyte absorbed therein. The anode protection layer may comprise a gel comprising a compound of formula (I). The anode protection layer may comprise a polymer and a compound of formula (I). The anode protection layer may prevent or retard formation of lithium metal dendrites of a metal battery.

The compound of formula (I) may be an ionic liquid. In the battery, the ionic liquid may form a gel with a polymer.

In some preferred embodiments, none of the R¹ groups are linked. Optionally according to these embodiments, each R¹ is independently a C₁₋₂₀ alkyl group wherein one or more non-adjacent C atoms of the alkyl group may be replaced with O, S, CO or COO and one or more H atoms of the alkyl group may be replaced with F.

Preferred R¹ groups include C₁₋₂₀ alkyl wherein one or more C atoms other than the C atom bound to O of OR¹ or a terminal C atom may be replaced with O, and one or more H atoms may be replaced by F.

By “terminal C atom” of an alkyl group as used herein is meant the C atom of the methyl group or methyl groups at the chain end or chain ends of a linear or branched alkyl, respectively.

In some embodiments, each R¹ is the same.

In some embodiments, the compound contains two or more different R¹ groups.

In some embodiments, R¹ groups of formula (I) are linked and the compound of formula (I) has formula (Ia):

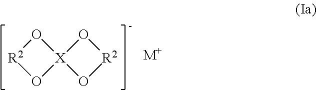

wherein R² in each occurrence is independently a divalent organic group.

Optionally, R² is selected from a C₆₋₂₀ arylene group, e.g. 1,2-phenylene, which may be unsubstituted or substituted with one or more substituents; a bi-arylene group, for example 2,2′-linked biphenylene; ethylene; and propylene, each of which may be unsubstituted or substituted with one or more substituents. Optionally, substituents are selected from F alkyl wherein one or more non-terminal C atoms of the C₁₋₁₂ alkyl may be replaced with F and one or more C atoms of the C₁₋₁₂ alkyl may be replaced with O.

Preferably, M⁺ is an alkali metal cation, more preferably a lithium cation.

Preferably, M⁺ is a solvated cation.

Preferably, the solvent of the solvate is selected from solvents comprising at least one ether group.

Preferably, the solvent contains two or more groups capable of coordinating to the metal cation.

The solvent may be selected from C₂₋₁₀ alkylene carbonates, di(C₁₋₁₀ alkyl) carbonates, linear and cyclic compounds containing one or more ether groups and, optionally, one or more groups selected from hydroxyl and carboxylate groups.

Exemplary solvents include, without limitation, propylene carbonate, ethylene carbonate, dimethyl carbonate, tetrahydrofuran, dimethoxyethane, diglyme (diethylene glycol dimethyl ether), triglyme (triethylene glycol dimethyl ether), tetraglyme (tetraethylene glycol dimethyl ether) and crown ethers, for example 12-Crown-4 and 1-aza-12-Crown-4.

The compound may contain more than one solvent of a solvate.

Optionally, a metal battery as described herein contains no solvent, or only a small amount of solvent, preferably no more than 10 moles of solvate per mole of the metal cation. The presence of a small amount of solvent may increase the ionic conductivity of the compound of formula (I). This increase may be due to solvation of the metal cation; where solvation takes place, it will be understood that some but not necessarily all of the solvent present in the battery solvates the metal cation. The presence of a small amount of organic solvent such as an alkylene carbonate or an ether-containing solvent may enhance ionic conductivity whilst significantly reducing flammability as compared to an ionic compound dissolved in a large volume of such a solvent.

Accordingly, a battery as described herein preferably comprise no more than 10 moles of solvent, more preferably no more than 7 moles or no more than 5 moles of solvent, per mole of metal cation. Preferably, the compound contains at least 0.5 moles or at least 1 mol of solvent per mole of metal cation.

The amount of solvating solvent in a compound of formula (I) may be determined from a ¹H NMR spectrum of the compound following vacuum treatment to remove free (non-solvating) solvent by integration of ¹H NMR peaks corresponding to the solvent and peaks corresponding to the groups —O—R¹.

The compound of formula (I) may be formed by reacting a compound of formula (II) and at least one compound selected from formulae (IIIa) and (IIIb):

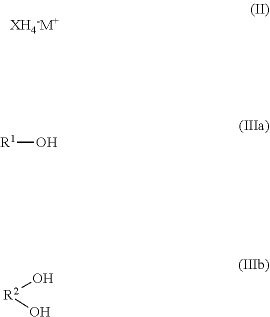

It will be understood that the compounds of formulae (IIIa) and (IIIb) may be selected according to the desired R₁ and R² groups of formula (I).

Exemplary compounds of formula (II) include, without limitation, lithium aluminium hydride (LiAlH₄) and lithium borohydride (LiBH₄)

Exemplary compounds of formula (IIIa) include, without limitation:
C₁₋₂₀ alkyl monohydric alcohols which may be non-fluorinated or wherein one or more, optionally all, H atoms of the C₁₋₂₀ alkyl may be replaced with F, for example ethanol, isopropanol, 1H,1H,5H-octafluoro-1-pentanol and pentadecafluoro-1-octanol;
ether monohydric alcohols which may be non-fluorinated, partially fluorinated or perfluorinated for example 2-ethoxyethanol, diethylene glycol monoethyl ether, 1H,1H-perfluoro-3,6-dioxaheptan-1-ol, 1H,1H-perfluoro-3,6,9-trioxadecan-1-ol, 1H,1H-perfluoro-3,6-dioxadecan-1-ol and 1H,1H-perfluoro-3,6,9-trioxatridecan-1-ol; and
mono-carboxylic acid compounds, for example C₁₋₂₀ alkyl carboxylic acids wherein one or more non-adjacent C atoms other than terminal C atoms or the C atom adjacent to the carboxylic acid group may be replaced with O and one or more H atoms may be replaced with F. Examples include, without limitation: perfluoroalkyl carboxylic acids, for example trifluoroacetic acid; perfluoroalkyl ether carboxylic acids; and alkyl ether carboxylic acids.

Exemplary compounds of formula (IIIb) include alkane diols wherein one or more non-adjacent, non terminal C atoms other than the C atom bound to O of R²—O may be replaced with O; aromatic diols; dicarboxylic acids; and compounds having one hydroxyl and one carboxylic acid group, each of which may be unsubstituted or substituted with one or more substituents, optionally non-fluorinated, partially fluorinated or perfluorinated.

Exemplary compounds of formula (IIIb) include ethylene glycol, catechol (1,2-dihydroxybenzene), oxalic acid and fluorinated derivatives thereof.

In some embodiments, the reaction is carried out with only one compound selected from compounds of formulae (IIIa) and (IIIb). According to these embodiments, the R¹ groups (and, therefore, each R² group in the case of compounds of formula (II)) are all the same.

In some embodiments, the reaction is carried out with two or more compounds selected from compounds of formulae (IIIa) and (IIIb). According to these embodiments, the R1 groups may be different. The ratio of different R¹ groups may be selected according to the ratio of the compounds of formulae (IIIa) and (IIIb) and their relative reactivity.

If the metal cation M⁺ is a solvated cation then in some embodiments the solvent of the solvate is present in the reaction mixture containing the compound of formula (II) and the compound of formula (IIIa) and/or (IIIb).

In some embodiments, the solvent of a compound of formula (I) containing a solvated cation may be replaced with a different solvent. Methods of changing the solvent of a solvate include, without limitation, driving off a solvent of a compound of formula (I) by heat treatment and replacing it with another solvent capable of solvating the cation; and contacting a compound of formula (I) with a solvent which coordinates more strongly to the cation than an existing solvating solvent, for example by treating a compound of formula (I) having a monodentate solvate solvent with a bi-dentate or higher-dentate ligand.

The battery may comprise a polymer comprising a repeat unit of formula (IV):

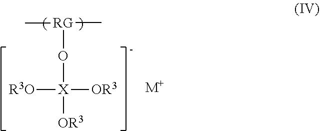

wherein RG is a repeating group of the polymer; R³ is a substituent; and X and M⁺ are as described above.

R³ may be a polymeric chain or a substituent R¹ as described above.

The polymer may be formed by reacting a compound of formula (II) as described above with a starting polymer having a backbone repeating group substituted with a hydroxyl or carboxylic acid group. The reaction may be performed in the presence of a compound of formula (IIIa) or (IIIb); the ratio of polymer:non-polymer groups may be selected according to the ratio of the starting polymer to the compounds of formula (IIIa) and/or (IIIb) and their relative reactivities.

The polymer may be formed by reacting a compound of formula (I) as described above with a starting polymer.

The starting polymer may be, for example, cellulose, optionally in a power or fibrous form.

### Battery Formation

Formation of a metal battery as described herein may comprise deposition of a compound of formula (I) onto or over a current collector. The compound of formula (I) may be absorbed into a polymer disposed on the current collector surface. The compound of formula (I) may be deposited from a formulation containing the compound dissolved or dispersed in a solvent or solvent mixture. Optionally, a formulation comprising the compound of formula (I) contains no more than 20 moles of solvent per mole of M⁺, optionally no more than 20 moles of solvent per mole of M⁺, and/or no solvent other than any solvating solvent as described herein. It will be understood that a battery formed using such a formulation will contain no more than 20 moles of solvent per mole of M⁺, and/or no solvent other than any solvating solvent as described herein

The formulation may comprise a polymer additional material dissolved in the solvent or solvents.

### EXAMPLES

### Compound Example 1

Compound Example 1 was prepared according to the following method:

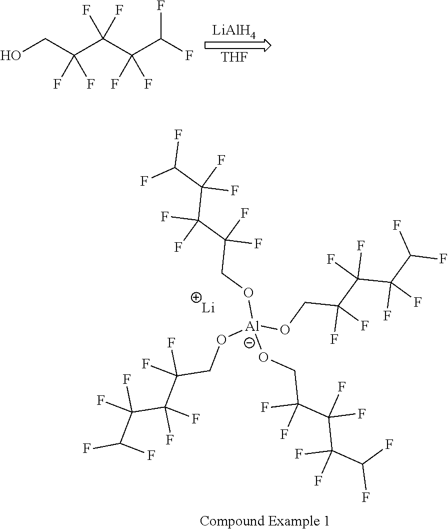

To a solution of 2,2,3,3,4,4,5,5-octafluoropentan-1-ol (“OFP”, 5 ml, 35.8 mmol) in anhydrous 1,2-dimethoxyethane (1,2-DME) (10 ml), a solution of lithium aluminium hydride (9 ml, 9.0 mmol, 1.0M in tetrahydrofuran) was added between 5ₜC and room temperature. The resulting mixture was stirred at room temperature for 30 minutes, then heated to 60° C. for 30 minutes. The excess solvent was removed under reduced pressure (3.0×10⁻² mbar) at 25° C. for 4 hours to yield a thick gel.

¹H NMR (600 MHz) in deuterated THF: δ (ppm), 3.29 (s, CH₃ from 1,2-DME, 6.24H), 3.45 (s, CH₂ from 1,2-DME, 4.22H), 4.16 (t, CF₂CH₂, J=14 Hz, 8H), 6.69 (tt, CF₂CF₂H, J=51.6 Hz, J=5.9 Hz, 4H).

From integration of NMR peaks (FIG. 4), it was calculated that for four molecules of OFP in the product, which correspond to one lithium cation there is 1.05 molecules of 1,2-DME present as residual solvent.

### Cell Examples

A model system was used that allowed the plating/stripping Coulombic Efficiency (CE=charge “OUT”/charge “IN”) of coin cell devices to be determined by electrochemical methods.

Galvanostatic cycling experiments were conducted on 2032-type coin cell (casings purchased from Cambridge Energy Solutions) devices having a bare Cu or Zn electrode (diameter 15 mm) a fluoro-silicone stencil, shaped as a disk of diameter 155 mm, with a circular hole of diameter 5 mm cut in its middle. The hole was filled with 30 μl of electrolyte solution of Compound Example 1 with 30 v/v of propylene carbonate (PC).

On top of the stencil, a lithium disk and a stainless steel spacer were placed consecutively, plus a wave spring and the coin cell top, followed by crimping. The thickness of the stencil in the crimped cell was 360 μm.

The electrolyte and all coin cell devices were prepared and assembled in a rigorously dry and oxygen-free Ar-filled MBraun glovebox.

### Measurement

Electrochemical measurement was performed using an Arbin battery testing system (Arbin Instruments). Cycling Coulombic efficiency was determined by calculating the ratio of the charge passed during stripping to the total charge passed during plating.

The galvanostatic cycling experiment was carried out as follows:
1. Apply a plating current density of −0.2 (or −0.5) mA·cm⁻² to the working electrode (referred to hereinafter as plating) for 60 minutes
2. Application of a stripping current density of 0.2 (or 0.5) mA·cm⁻² to a cut-off voltage of 1 V versus the Li/Li⁺ redox couple (referred to hereafter as stripping) for 60 minutes
3. 60 minutes rest, when no current was applied
4. Repeat steps 1-3 more than 160 times.

### Results

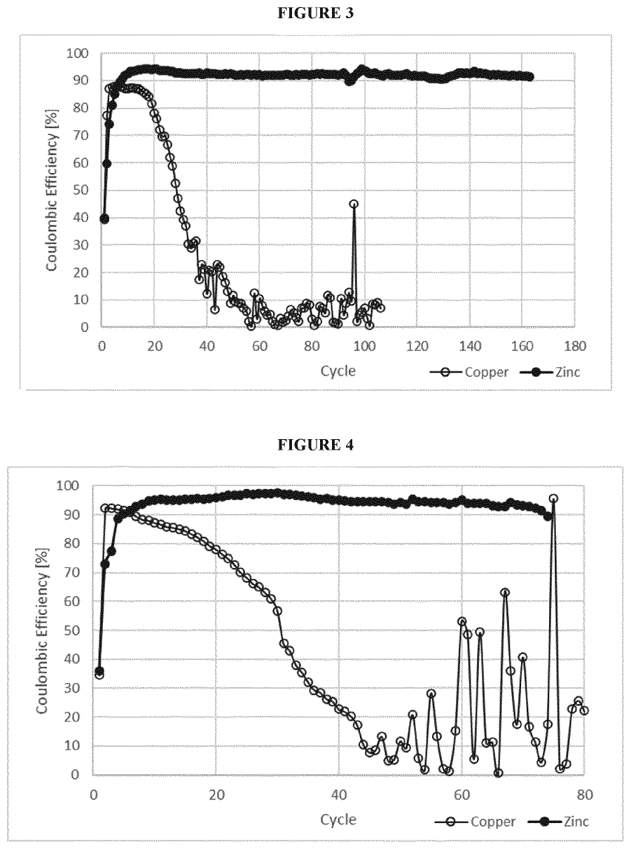

A comparison of the cycling Coulombic efficiencies of cells containing Cu foil electrode and Zn foil electrode shows that the presence of zinc is beneficial to the cycling Coulombic efficiencies of the cells at 0.2 mA/cm² (FIG. 3) and at 0.5 mA/cm² (FIG. 4).

The Coulombic efficiency of the cell with Zn is maintained over a much higher number of cycles than the device with copper. Coulombic efficiency drops to less than 20% at ˜50 cycles for 0.2 mA/cm² and at ˜40 cycles for 0.5 mA/cm² for devices with copper whereas the Coulombic efficiencies of cells using zinc are stable above 90% for up to 160 cycles at 0.2 mA/cm² and up to 70 cycles at 0.5 mA/cm².

Without wishing to be bound by any theory, a lithium-zinc alloy is formed which prevents the accumulation (plating) of lithium metal on the charge collector and hence delays the formation of “dead” lithium, i.e. lithium which is not in contact with the anode, and lithium dendrites.

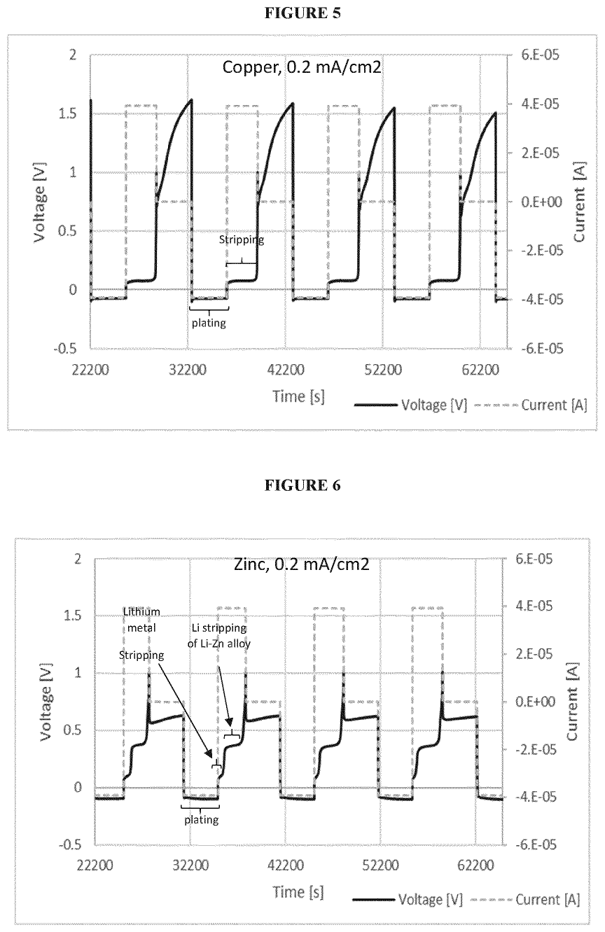

The formation of the lithium-zinc alloy can be observed on the voltage profile curves during the plating and stripping cycling, shown in FIGS. 5-8.

FIGS. 5 and 6 show typical voltage profiles for cells cycled at 0.2 mA/cm2. The devices with copper (FIG. 5) show a single and uniform plateau for both plating of lithium metal (at about −100 mV) and stripping of lithium metal (at about +100 mV) symmetrical to 0V.

The devices with zinc (FIG. 6) show a lithium metal plating potential at about −100 mV, at a very similar value observed for the devices with copper, and two distinct plateaus during the stripping step: at ˜100 mV which corresponds to the lithium metal stripping and at ˜350 mV which can be ascribed to the stripping of lithium in a lithium-zinc alloy which is formed during the plating step.

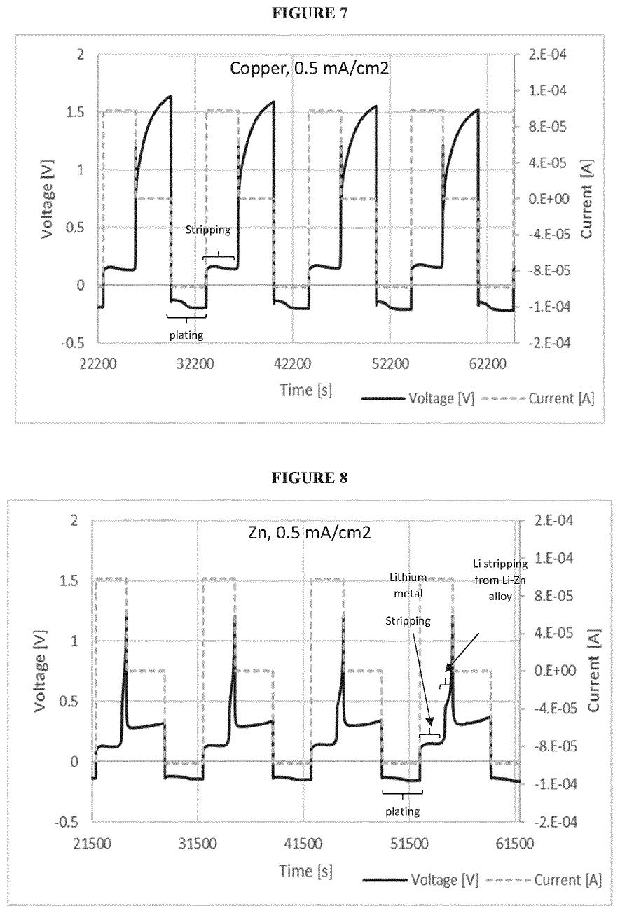

FIGS. 7 and 8 show typical voltage profiles for cells cycled at 0.5 mA/cm². The devices with copper (FIG. 7) show a single and uniform plateau for both plating of lithium metal (at about −150 mV) and stripping of lithium metal (at about +150 mV) symmetrical to 0V.

The devices with zinc (FIG. 8) show a lithium metal plating potential at −150 mV, at a very similar value observed for the devices with copper, and again two distinct plateaus during the stripping step: at ˜150 mV which corresponds to the lithium metal stripping and at ˜500 mV which can be ascribed to the stripping of lithium in a lithium-zinc alloy.

1. A metal battery comprising an anode, a cathode, an anode current collector, a cathode current collector and a compound of formula (I) disposed between the anode and cathode: 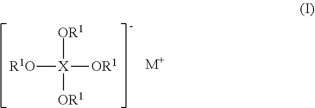
wherein X is Al or B; R¹ in each occurrence is independently a substituent; and two R¹ groups may be linked to form a ring; and M⁺ is a metal cation, and wherein the anode current collector comprises a layer comprising zinc in contact with the anode.

2. The metal battery according to claim 1 wherein none of the R¹ groups are linked.

3. The metal battery according to claim 2 wherein each R¹ is independently a C₁₋₂₀ alkyl group wherein one or more non-adjacent C atoms of the alkyl group may be replaced with O, S, CO or COO and one or more H atoms of the alkyl group may be replaced with F.

4. The metal battery according to claim 3 wherein each R¹ is independently selected from alkyl and alkyl ether groups wherein one or more H atoms may be replaced with F.

5. The metal battery according to claim 1 wherein each R¹ is the same.

6. The metal battery according to claim 1 wherein the compound contains at least 2 different R¹ groups.

7. The metal battery according to claim 1 wherein R¹ groups of formula (I) are linked and the compound of formula (I) has formula (Ia): 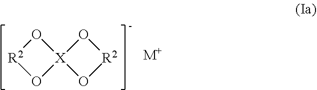
wherein R² in each occurrence is independently a divalent organic group.

8. The metal battery according to claim 1 wherein M⁺ is an alkali metal ion.

9. The metal battery according to claim 8 wherein M⁺ is a lithium ion.

10. The metal battery according to claim 1 wherein M⁺ is a solvated cation.

11. A metal battery or metal ion battery according to claim 1 wherein a solvent:M⁺ molar ratio of the battery is no more than 10:1.

12. A metal battery according to claim 1 comprising an anode protection layer comprising the compound of formula (I) disposed between the anode and cathode.

13. A formulation comprising a solvent and a compound of formula (I): 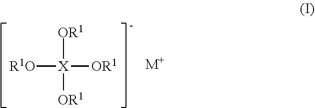
wherein X is Al or B; R¹ in each occurrence is independently a substituent and two R¹ groups may be linked to form a ring; and M⁺ is a cation, and wherein the solvent comprises a carbonate group.

14. The formulation according to claim 13 wherein the solvent is selected from C₂₋₁₀ alkylene carbonates and di(C₁₋₁₀ alkyl) carbonates.

15. The formulation according to claim 13 wherein a ratio of moles of solvent:moles of M⁺ in the formulation is no more than 20:1.
